(19) United States
(12) Patent Application Publication
(10) Pub. No.: US 2025/0291107 A1
(43) Pub. Date: Sep. 18, 2025

(54) Hollow Core Optical Waveguiding Enabled by Zero-Index Materials

(71) Applicant: The Regents of the University of California, Oakland, CA (US)

(72) Inventors: Ho Wai Lee, Irvine, CA (US); Leon Zhang, Buena park, CA (US)

(21) Appl. No.: 18/861,376

(22) PCT Filed: May 2, 2023
(86) PCT No.: PCT/US23/20700

§ 371 Date: Oct. 29, 2024

Related U.S. Application Data
(60) Provisional application No. 63/337,968, filed on May 3, 2022.

(51) Int. Cl. G02B 6/02; G02B 6/036

(52) U.S. Cl. CPC G02B 6/02328; G02B 6/02366; G02B 6/03605

(57) ABSTRACT

Hollow core optical waveguiding enabled by zero-index materials are provided. In one embodiments, a zero-index optical fiber is provided, the zero-index optical fiber comprising: a core comprising air for propagating light; and a cladding configured to surround the core, wherein the cladding comprises a zero-index material. The zero-index material including transparent conducting oxides such as indium tin oxide.

### CROSS-REFERENCE TO RELATED APPLICATION

The current application claims priority to U.S. Provisional Patent Application No. 63/337,968, filed on May 3, 2022, the disclosure of which is incorporated herein by reference.

### FIELD OF THE INVENTION

The present invention generally relates to communications and more specifically to hollow core optical waveguiding enabled by zero-index materials.

### BACKGROUND

Optical communications or optical telecommunications may be described as communication using light to carry information. Typically, an optical communication system may use a transmitter, which may encode a message (e.g., information) into an optical signal, a channel, which may carry the signal to its destination, and a receiver, which may reproduce the message from the received optical signal. Optical communication systems may utilize optical fibers, optical amplifiers, lasers, switches, routers, and other related technologies.

### SUMMARY OF THE INVENTION

The various embodiments of the present hollow core optical waveguiding enabled by zero-index materials contain several features, no single one of which is solely responsible for their desirable attributes. Without limiting the scope of the present embodiments, their more prominent features will now be discussed below. In particular, the present hollow core optical waveguiding enabled by zero-index materials will be discussed in the context of air-guided optoelectronic optical fibers utilizing zero-refractive index (may also be referred to as “zero-index” or “epsilon-near-zero (ENZ)”) materials. However, the use of particular optical fibers and particular zero-index materials are merely exemplary and various other implementations and/or zero-index materials may be utilized as appropriate to the requirements of a specific application in accordance with various embodiments of the invention. Further, the use of optical telecommunications is also merely exemplary and various other applications utilizing hollow core optical waveguiding enabled by zero-index materials may be considered as appropriate to the requirements of a specific application in accordance with various embodiments of the invention. After considering this discussion, and particularly after reading the section entitled “Detailed Description,” one will understand how the features of the present embodiments provide the advantages described here.

One aspect of the present embodiments includes the realization that the present embodiments may improve next-generation optical communications by orders of magnitude in transmission speed for long-distance communication and time-sensitive short haul communication such as, but not limited to, data center interconnects, high-performance computing, and high-frequency trading. In addition, air-guided zero-index fibers may be utilized in high power fiber lasers with radiation >1000 GW/cm2 for advanced in-fiber laser applications such as, but not limited to, laser surgery/spectroscopy, laser cutting/welding, military applications (current state-of-the-art with power range ˜10 GW/cm2), novel gas-filled/discharge lasers (which is not feasible in glass-based fiber), and in-fiber molecular/gas sensing and laser-break-down spectroscopy that may use high peak power for plasma creation.

Another aspect of the present embodiments includes the realization that conventional optical fibers may guide light based on total-internal reflection between a glass core, light carrying material, and cladding, which surrounds the core, over long distances with low optical loss in applications such as long-distance optical communication (high-speed internet) and fiber lasers. Similar to the Moore's Law in electronic devices, optical fiber communications may follow Keck's Law (speed capacity growth exponentially over years) and may be approaching maximum capabilities because of two critical fundamental limits of conventional optical fibers. First, the speed, power, and transmission of light being guided in the conventional optical fiber may be limited by the glass materials of the core, cladding and the guiding mechanism. For instance, optical fibers may transmit only limited laser power due to their low damage threshold and nonlinear effects, requiring amplification (e.g., every 80 km) to compensate for optical loss. Second, the optical properties of conventional optical fibers may be fixed after the fiber drawing fabrication due to poor optoelectronic or nonlinear optical effects. Therefore, there are significant scientific and technical gaps that could be filled for optical communication technology breakthroughs and for efficient next-generation optical fiber technology with enhanced speed and capabilities. As further described below, the present embodiments address such gaps by introducing a fundamentally different optical guiding mechanism via an integration of zero-refractive index materials (may also be referred to as “zero-index materials”) into optical fibers for enhanced light air-guiding and active functionalities.

In a first aspect, a zero-index optical fiber is provided, the zero-index optical fiber comprising a core comprising air for propagating light; and a cladding configured to surround the core, wherein the cladding comprises a zero-index material.

In an embodiment of the first aspect, the air has a higher refractive index than the zero-index material.

In another embodiment of the first aspect, the air has a refractive index equal to 1.

In another embodiment of the first aspect, the zero-index material has a refractive index near 0.

In another embodiment of the first aspect, the zero-index material has a real part of permittivity of material near 0.

In another embodiment of the first aspect, the light is guided in the zero-index optical fiber via total internal reflection.

In another embodiment of the first aspect, the zero-index optical fiber is electrically tunable.

In another embodiment of the first aspect, the zero-index optical fiber further comprises a negative terminal layer and a positive terminal layer.

In another embodiment of the first aspect, the negative terminal layer comprises the zero-index material.

In another embodiment of the first aspect, the positive terminal layer comprises gold (AU).

In another embodiment of the first aspect, the zero-index optical fiber is fabricated by coating a layer of zero-index material on an inside of a glass capillary fiber.

In another embodiment of the first aspect, where coating the layer of zero-index material on the inside of the glass capillary fiber is performed using atomic layer disposition.

In another embodiment of the first aspect, the zero-index material can be any material that exhibits zero-index property.

In another embodiment of the first aspect, the zero-index material can be any material that exhibits epsilon-near-zero property.

In another embodiment of the first aspect, the zero-index material is a transparent conducting oxide material.

In another embodiment of the first aspect, the transparent conducting oxide material is an indium tin oxide (ITO) material.

In another embodiment of the first aspect, the propagated light has various wavelengths and the ITO material can operate in a telecommunication system.

In another embodiment of the first aspect, the telecommunication system utilizes wavelength λ=1550 nm.

In another embodiment of the first aspect, the core has a thickness of 500 nm or larger.

In another embodiment of the first aspect, the cladding has a thickness of 300 nm or larger.

### BRIEF DESCRIPTION OF THE DRAWINGS

The various embodiments of the present hollow core optical waveguiding enabled by zero-index materials now will be discussed in detail with an emphasis on highlighting the advantageous features. These embodiments depict the novel and non-obvious features of hollow core optical waveguiding enabled by zero-index materials shown in the accompanying drawings, which are for illustrative purposes only. These drawings include the following figures:

FIG. 1A is a diagram illustrating an overview of zero-index optical fibers in accordance with an embodiment of the invention.

FIG. 1B is a graph illustrating permittivity and refractive index of various wavelengths for an indium tin oxide (ITO) material in accordance with an embodiment of the invention.

FIG. 2A is a schematic diagram and mode profile of a fundamental core mode of a hollow core ENZ optical fiber with different ENZ thickness in accordance with an embodiment of the invention.

FIG. 2B is a graph illustrating simulated loss of a fundamental core mode of a hollow core ENZ optical fiber with different ENZ thickness in accordance with an embodiment of the invention.

FIG. 3A is a graph illustrating simulated loss spectra for hollow core ENZ optical fibers with different material losses of ITO in accordance with an embodiment of the invention.

FIG. 3B is a graph illustrating simulated loss of a fundamental core mode of a hollow core ENZ optical fiber for different ENZ thicknesses and varied loss in accordance with an embodiment of the invention.

FIG. 4A is a graph illustrating simulated loss spectra for hollow core ENZ optical fibers with different core diameters and ENZ layer thicknesses at an ENZ wavelength of 1550 nm in accordance with an embodiment of the invention.

FIG. 4B is a graph illustrating comparison of percent change in loss for ENZ optical fibers with different air-core diameters normalized with a conventional fiber (i.e., a fiber without an ENZ layer) in accordance with an embodiment of the invention.

FIG. 5A are diagrams illustrating a zero-index capillary fiber in accordance with an embodiment of the invention.

FIG. 5B are diagrams illustrating a zero-index guided anti-resonance fiber in accordance with an embodiment of the invention.

FIG. 5C are diagrams illustrating an electrically tunable zero-index hollow core fiber in accordance with an embodiment of the invention.

FIG. 6 is a flow diagram illustrating a process for fabricating a zero-index optical fiber in accordance with an embodiment of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features.

Turning now to the drawings, optical fibers with hollow core optical waveguiding enabled by zero-index materials (may be referred to as “zero-index optical fibers” or “ENZ optical fibers”) are provided. In many embodiments, the present embodiments may include an air-guided optical fiber technology that uses zero-refractive index (may also be referred to as “zero-index”) materials as a guiding medium. In various embodiments, light may be guided in the “air” surrounded by one or more zero-refractive index materials at the maximum speed of light with extremely high power transport and electrical controls, overcoming the significant limitations of conventional optical fibers where light properties are largely limited by the glass core material. For example, conventional optical fiber glass core's may slow down the speed of light based on the index of refraction, e.g. v=c/n. Zero-index optical fibers may include an open air-filled core surrounded by zero-refractive index material. Since air has a higher refractive index (n=1) than the zero-index material (n˜0), the light may be guided in air via total internal reflection with 100% speed, as in a vacuum (improving speed by a factor of two compared with glass), enabling the zero-index air-guided optical fiber to lead to an order of magnitude improvement in transmission speed (together with multiplexing technology). In many embodiments, conducting oxide zero-index materials that exhibit extremely high damage thresholds and electrical tunability, may be suitable for a zero-index hollow core fiber with high power guidance and dynamic optical response. In various embodiments, zero-index optical fibers may utilize atomic layer deposition (ALD) techniques and wet chemistry synthesis to fabricate a conducting oxide (e.g., ITO, AZO) layer inside the fiber's hollow channel.

In several embodiments, the present embodiments may include an epsilon-near-zero (ENZ) optical fiber configuration, with a hollow air core where light propagates through, and cladding made of ENZ material, which may have its real part of the permittivity reduced to zero at a certain wavelength, leading to an index of refraction less than that of air. As further described below, such structures may create an index profile as step-index optical fiber, with a high index air core, and a lower index ENZ cladding, which allows for total internal reflection and light guiding. In a variety of embodiments, the ENZ hollow core fiber configuration may provide unique light guiding properties and offer drastic improvement in speed of transmission, since light propagates faster in air than in glass. Zero-index optical fibers in accordance with embodiments of the invention are discussed further below.

### Zero-Index Optical Fibers

Zero-index optical fibers may transmit light faster than conventional optical fibers. For example, in various embodiments, zero-index optical fibers may include a so-called “hollow core” of air which may allow light to transmit faster than conventional solid core fibers. Further, zero-index optical fibers may guide light with much higher power since there is typically no material damage when using air. In addition, compared to other hollow-core fiber designs, the present embodiments may be simpler and easier to fabricate, and operate in different guiding mechanism.

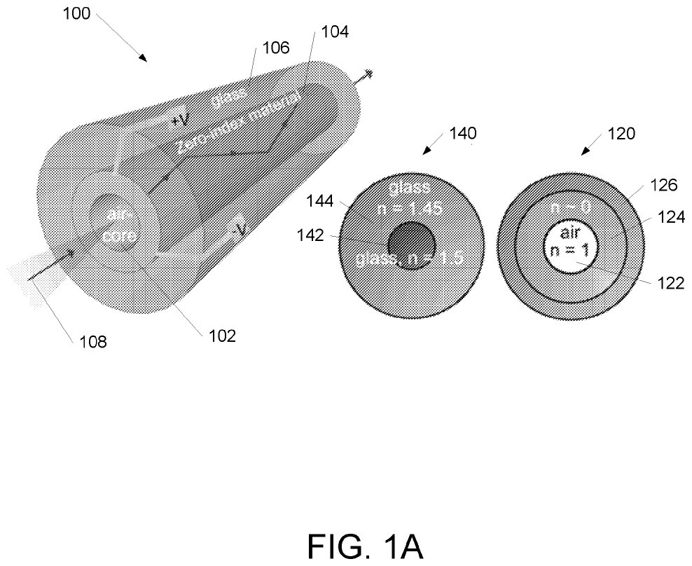

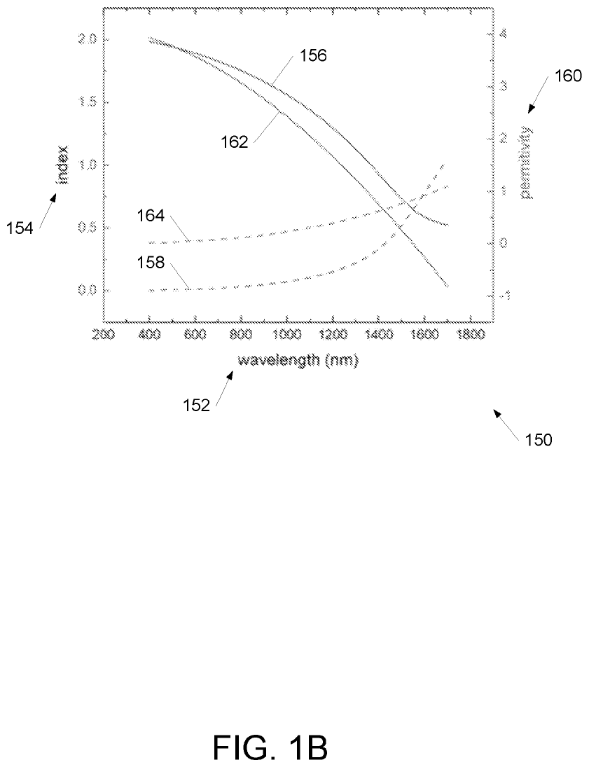

A diagram illustrating an overview of zero-index optical fibers in accordance with an embodiment of the invention is shown in FIG. 1A. In many embodiments, active zero-index optical fibers (e.g., optical fiber 100) may be utilized for various applications, including but not limited to, novel optical fiber communications, lasers, and/or spectroscopy technologies. Further, zero-index optical fibers (e.g., optical fiber 100) may allow for high speed, high power, and low loss transmission. In some embodiments, zero-index optical fibers (e.g., optical fiber 100) may also be electrically controllable. In several embodiments, the zero-index optical fiber 100 may include a zero-refractive index material 104 as a guiding medium for light 108. For example, light 108 may be guided in the air (e.g., air core 102) surrounded by the zero-refractive index material 104. In various embodiments, the light 108 may travel at a maximum speed of light with extremely high power transport and electrical controls. In several embodiments, the zero-index optical fiber 100 may also include a glass layer 106 such as, but not limited to a glass capillary fiber layer.

In reference to FIG. 1A, a cross-sectional view of a zero-index optical fiber 120 and a cross-sectional view of a conventional optical fiber 140 are illustrated. In many embodiments, the zero-index optical fibers (e.g., zero-index optical fiber 120) may be constructed similar to a conventional step-index fiber 140, but instead of having glass as the high index core 142 (e.g., glass n=1.5), the zero-index optical fibers may utilize air 122 (n=1), and the lower index glass cladding 144 (e.g., glass n=1.45) (may be replaced by a layer of zero-index material 124 (n˜0) such as, but not limited to, epsilon-near-zero (ENZ) material. For light near a certain tunable wavelength (e.g., the ENZ wavelength), the index of refraction of the material may become less than that of air. Thus, zero-index optical fibers may achieve a similar index profile as a conventional optical fiber, with a high index core, and a lower index cladding, allowing total internal reflection to confine light within the center hollow core. In some embodiments, the zero-index optical fibers may also include an outer glass layer 126.

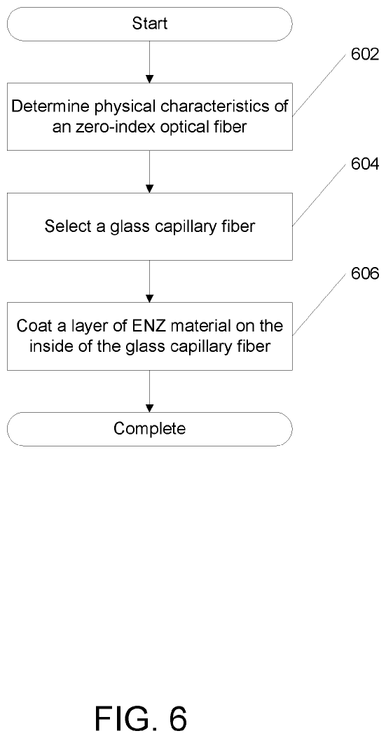

A process for fabrication a zero-index optical fiber in accordance with an embodiment of the invention is shown in FIG. 6. The process 600 may include determining (602) physical characteristics of the zero-index optical fiber such as, but not limited to, a diameter of the zero-index optical fiber, a thickness of a glass layer, a thickness of an ENZ layer, and/or a diameter of an air-core. In various embodiments, zero-index optical fibers may be fabricated by selecting (304) a glass capillary fiber and coating (306) a layer of ENZ material on the inside using various methods such as, but not limited to, atomic layer deposition. This way, both the diameter of the fiber (i.e., the air-core 122) and the thickness of the ENZ layer 124 may be tuned.

A graph illustrating permittivity and refractive index of various wavelengths for an indium tin oxide (ITO) material in accordance with an embodiment of the invention is shown in FIG. 1B. Near the ENZ wavelength (λ=1550 nm), the zero-index material may have an index of refraction less than that of air. Thus, the zero-index optical fiber (e.g., the zero-index optical fiber 100, as illustrate in FIG. 1A), may create a similar index profile as a conventional step-index fiber, with a high index core, and a lower index cladding, which allows for total internal reflection. In FIG. 1B, the graph 150 includes a first graph using a wavelength (nm) x-axis 152 and index y-axis 154 showing n values 156 and k values 158. Further, the graph 150 also includes a second graph using the wavelength (nm) x-axis 152 and a permittivity y-axis 160 that is overlaid on the first graph. In the second graph, values for εᵣ and εᵢ are illustrated. The dispersion data for the ENZ material may be determined experimentally from an indium tin oxide (ITO) sample, fabricated by magneton sputtering technique, using ellipsometry techniques.

Although zero-index optical fibers, properties, and processes of fabrication are discussed above with respect to FIGS. 1A-1B and 6, any of a variety of zero-index optical fibers including various zero-index materials and optical fiber configurations, and fabrication processes as appropriate to the requirements of a specific application may be utilized in accordance with embodiments of the invention. Results and discussion in accordance with embodiments of the invention are discussed further below.

### Results and Discussion

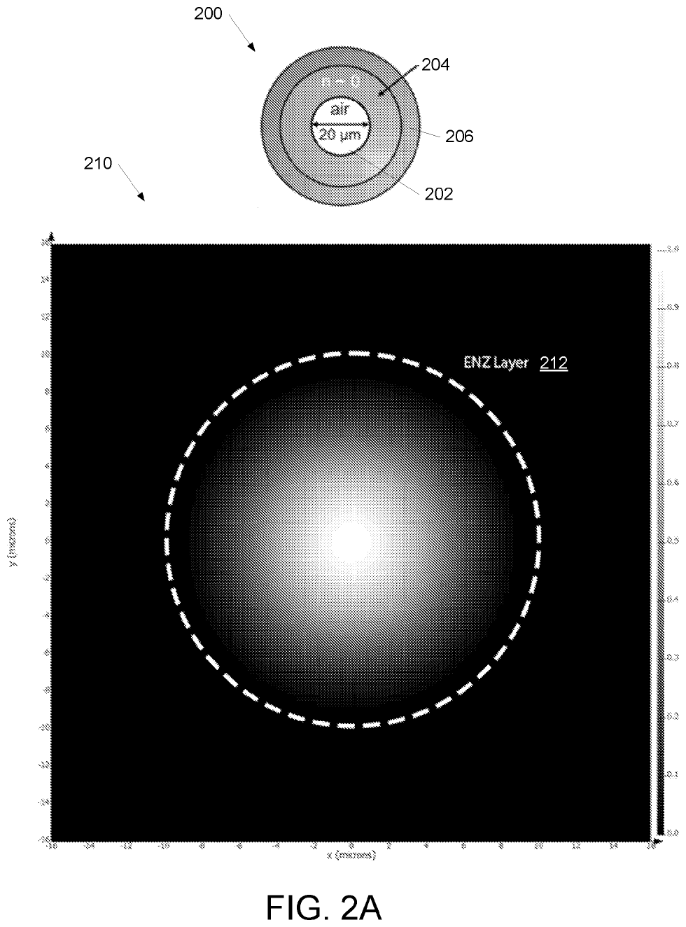

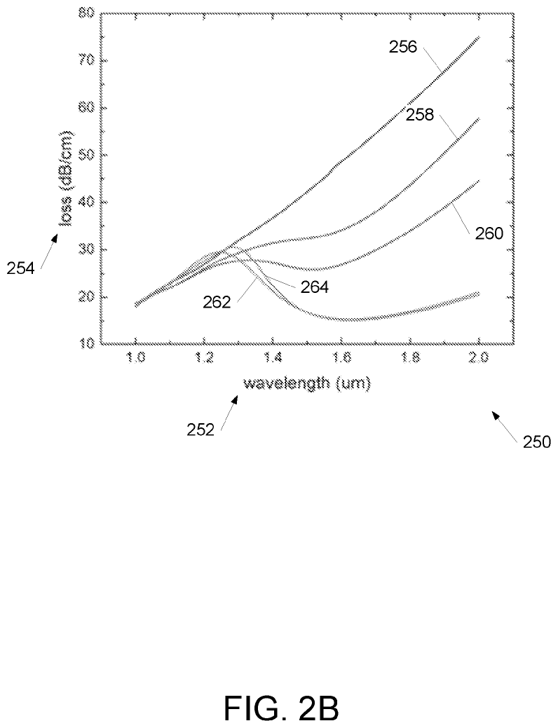

Full-wave numerical electromagnetic simulations may be performed using Lumerical's MODE solver. For example, the fundamental mode of the ENZ coated hollow core optical fiber may be simulated. A schematic diagram and mode profile of a fundamental core mode of a hollow core ENZ optical fiber with different ENZ thickness in accordance with an embodiment of the invention is shown in FIG. 2A. The diagram in FIG. 2A includes a schematic cross-sectional view of a fundamental core mode of a hollow core ENZ optical fiber 200 with varied thickness of the ENZ layer 204. The hollow core ENZ optical fiber 200 may also include an air-core 202 (e.g., 20 μm in diameter), an ENZ layer 204 (that may be varied in thickness), and a glass layer 206. The diagram in FIG. 2A also includes a mode profile of a fundamental core mode of a hollow core ENZ optical fiber 210. As shown in FIG. 2A, the fundamental mode of the ENZ hollow core fiber 210 may exhibit core mode with gaussian mode distribution. In many embodiments, the dimensions of the air-core region may be fixed, while the thickness of the ENZ layer 212 varied.

A graph illustrating simulated loss of a fundamental core mode of a hollow core ENZ optical fiber with different ENZ thickness in accordance with an embodiment of the invention is shown in FIG. 2B. The losses of the fundamental mode of the fibers are shown. The graph 250 includes a wavelength (μm) x-axis 252 and a loss (dB/cm) y-axis 254 and provides values for no ENZ 256, 40 nm ENZ thickness 258, 100 nm ENZ thickness 260, 400 nm ENZ thickness 262, and 1000 nm ENZ thickness 264. As illustrated, the ENZ layer may significantly reduce the loss of the fiber for long wavelengths with minimum loss at around the ENZ wavelength. In addition, for thick ENZ layers (e.g. 400 nm and 1000 nm), the loss of the core mode may be significantly reduced.

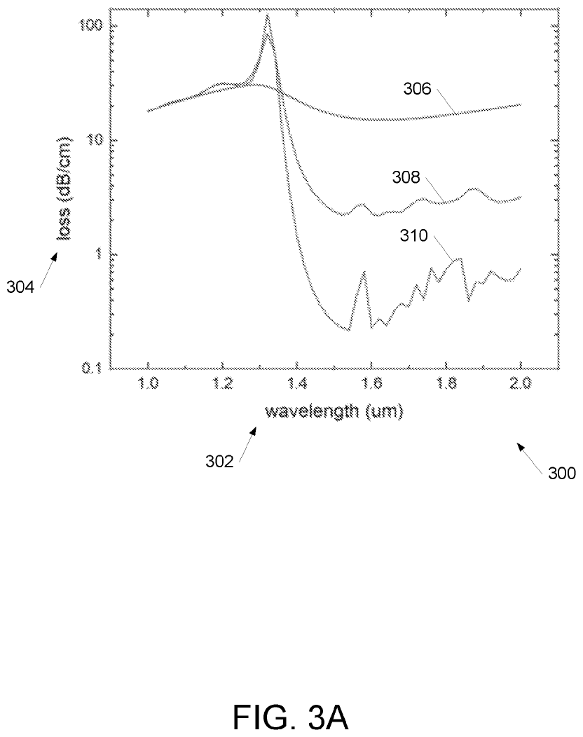

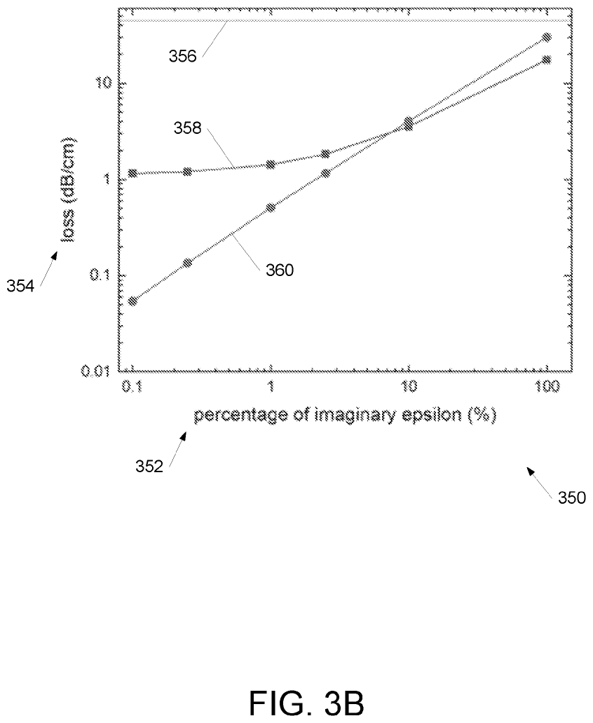

The effect of the loss of the guided optical fiber mode with the loss of the ENZ materials may be further investigated. The lower loss ENZ may be simulated by taking the existing dispersion of the ITO sample, then reducing the imaginary part of the permittivity by a set percentage for every wavelength, while assuming the real part of the permittivity unchanged. The thickness of ITO ENZ and the core diameter may be fixed at 1000 nm and 20 μm, respectively. A graph illustrating simulated loss spectra for hollow core ENZ optical fibers with different material losses of ITO in accordance with an embodiment of the invention is shown in FIG. 3A. The graph 300 includes a wavelength (μm) x-axis 302 and a loss (dB/cm) y-axis 304 and provides values for original loss 306, 10% loss 308, and 1% loss 310. As shown in FIG. 3A, the loss of the ENZ optical fiber reduces for two orders of magnitude near the ENZ wavelength when the ITO material loss is reduced to 1%. It should be noted that imaginary part of permittivity Im(ε)=0.02 takes place in aluminum nitride (AlN), a polar semiconductor close to the longitudinal optic (LO) phonon frequency of 27 THz. Further, the present embodiments may be optimized with ZnO:Al/ZnO metamaterials with the out-of-plane imaginary part of permittivity as low as 0.003 at 1885 nm, and dysprosium-doped cadmium oxide (CdO:Dy) multilayers.

In addition, the loss of the fundamental mode at a wavelength of 1550 nm changes as the imaginary part of the permittivity reduces to a percentage of its original value for two different thicknesses of ITO ENZ layer of 400 nm and 2000 nm may be investigated. A graph illustrating simulated loss of a fundamental core mode of a hollow core ENZ optical fiber for different ENZ thicknesses and varied loss in accordance with an embodiment of the invention is shown in FIG. 3B. The graph 350 includes a percentage of imaginary epsilon (%) x-axis 352 and a loss (dB/cm) y-axis 354 and provides values for loss without ENZ layer 356, 400 nm ENZ thickness 358, and 2000 nm ENZ thickness 360. The results show that the guiding efficiency of the fiber may be enhanced by further engineering of ENZ material. For instance, the loss reaches to ˜0.04 dB/cm for 2000 nm thickness of ENZ material and 0.1% of imaginary part of permittivity.

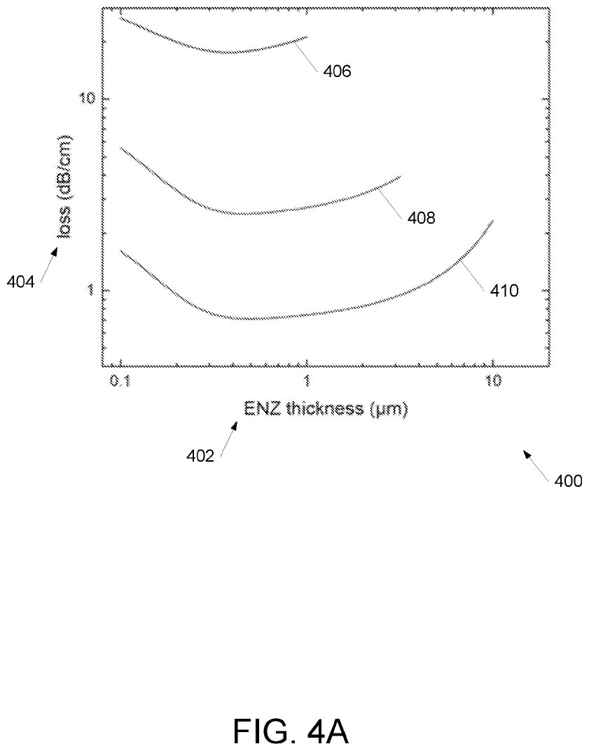

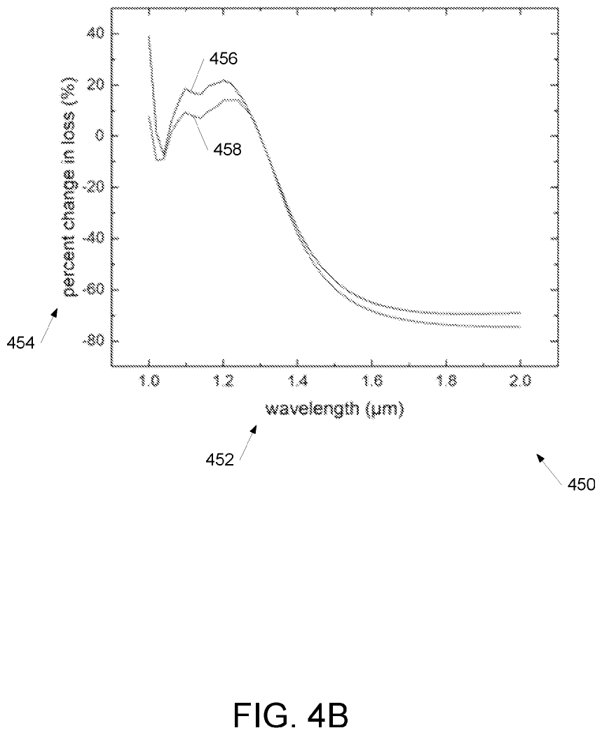

The fiber with different core diameters, while comparing how the loss of the fundamental mode at 1550 nm changes as the thickness of the ENZ layer is changed may also be explored. The imaginary part of permittivity used is the experimentally obtained ITO loss value. A graph illustrating simulated loss spectra for hollow core ENZ optical fibers with different core diameters and ENZ layer thicknesses at an ENZ wavelength of 1550 nm in accordance with an embodiment of the invention is shown in FIG. 4A. The graph 400 includes an ENZ thickness (μm) x-axis 402 and a loss (dB/cm) y-axis 404 and provides values for core diameters of 20 μm 406, 40 μm 408, and 60 μm. The thickness of ITO ENZ may be fixed at 1000 nm with core diameter of 20 μm. As shown in FIG. 4A, the results indicate that the loss of ENZ fiber reduces as the air core diameter decreases. In addition, certain ENZ thickness (˜600 nm) may lead to lower loss of the guided mode.

The fiber at two different core diameters was simulated, and the percent change in loss caused by the addition of the ENZ layer may be plotted. A graph illustrating comparison of percent change in loss for ENZ optical fibers with different air-core diameters normalized with a conventional fiber (i.e., a fiber without an ENZ layer) in accordance with an embodiment of the invention is shown in FIG. 4B. The graph 450 includes a wavelength (μm) x-axis 452 and a percent change in loss (%) y-axis 454 and provides values for air-core diameters of 20 μm 456 and 60 μm 458. As illustrated in FIG. 4B, the effect of the ENZ layer may be similar for different core diameters, with significant reduction of loss near the ENZ wavelength.

Although specific simulations, analysis, results, and interpretations for zero-index optical fibers are discussed above with respect to FIGS. 2A-4B, any of a variety of simulations, analysis, results, and interpretations for zero-index optical fibers as appropriate to the requirements of a specific application can be utilized in accordance with embodiments of the invention. Cartridge μFSE devices in accordance with embodiments of the invention are discussed further below.

### Fabrication Considerations

Zero-index materials may be integrated with optical fibers using advanced fabrication techniques. In some embodiments, zero-index based air-guiding may be utilized in different fiber types, such as, but not limited to, capillary fibers, anti-resonance hollow core optical fibers, and hollow core photonic crystal fibers. In some embodiments, electrically tunable optical properties may be achieved using conducting oxide materials' gate-tunability and field-effect heterostructure configurations.

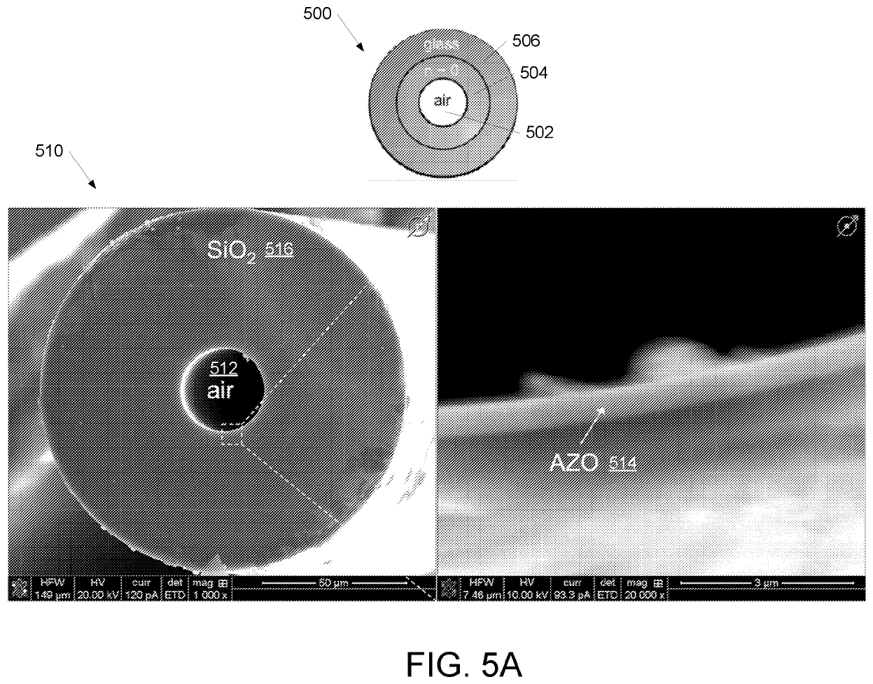

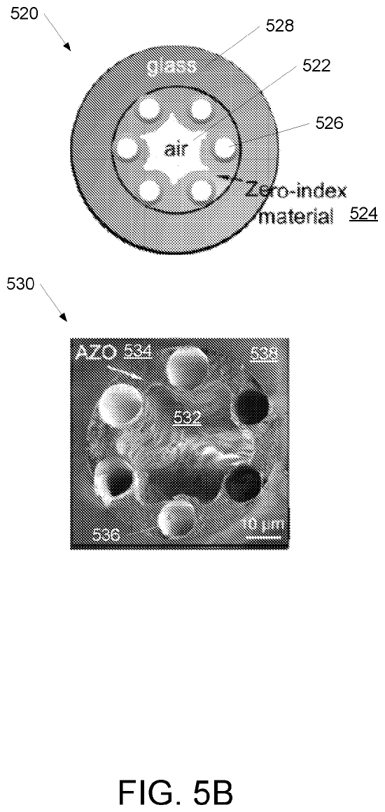

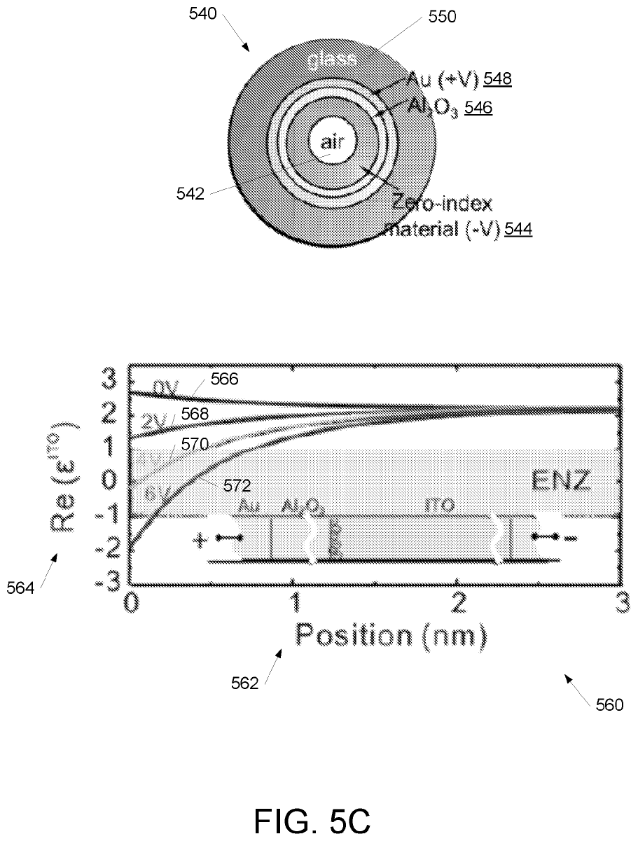

As described herein, simulations show that zero-index coated capillary fibers show optical guiding with a loss ˜1-2 orders of magnitude lower than similar fibers without zero-index materials. In some embodiments, zero-index layers may be coated routinely on hollow capillaries/fibers. Diagrams illustrating a zero-index capillary fiber in accordance with an embodiment of the invention are shown in FIG. 5A. The diagrams in FIG. 5A include a schematic cross-sectional view of a zero-index capillary fiber 500 and an imaged cross-sectional view of a zero-index capillary fiber 510. The schematic cross-sectional view illustrates the zero-index capillary fiber 500 having an air-core 502, a zero-index material layer 504, and a glass layer 506 such as, but not limited to a glass capillary fiber layer. The imaged cross-sectional view illustrates the zero-index capillary fiber 510 having an air-core 512, a zero-index material layer 514 made using a conducting oxide (e.g., AZO), and a glass layer (e.g., SiO₂) 516.

Diagrams illustrating a zero-index guided anti-resonance fiber in accordance with an embodiment of the invention are shown in FIG. 5B. The diagrams in FIG. 5B include a schematic cross-sectional view of a zero-index guided anti-resonance fiber 520 and an imaged cross-sectional view of a zero-index guided anti-resonance fiber 530. The schematic cross-sectional view illustrates the zero-index guided anti-resonance fiber 520 having an air-core 522, a zero-index layer having zero-index material 524 and one or more air holes 526, and a glass layer 528. The imaged cross-sectional view illustrates the zero-index guided anti-resonance fiber 530 having an air-core 532, a zero-index layer having zero-index material 534 and one or more air holes 536, and a glass layer 538.

Diagrams illustrating an electrically tunable zero-index hollow core fiber in accordance with an embodiment of the invention are FIG. 5C. The diagrams in FIG. 5C include a schematic cross-sectional view of the electrically tunable zero-index hollow core fiber 540 and a graph 560 illustrating characteristics of the electrically tunable zero-index hollow core fiber. The schematic cross-sectional view illustrates the electrically tunable zero-index hollow core fiber 540 having an air-core 542, a negative voltage (−V) terminal layer (e.g., a zero-index material layer 544), an intermediate layer (e.g., a Al₂O₃, layer), and a positive voltage (+V) terminal layer (e.g., an AU layer), and a glass layer 550. The graph 560 includes a position (nm) x-axis 562 and a Re (¿ITO) y-axis 564 and provides values for 0V 566, 2V 568, 4V 570, and 6V 572.

In many embodiments, the light guiding properties of zero-index optical fibers (e.g., loss, mode profile, polarization states) using cut-back loss measurement techniques and far-field detections may be further investigated. In addition, different deposition/synthesis conditions and fiber geometries to reduce the loss of the zero-index optical fibers may be considered. Further, electrically-tunable zero-index materials may be integrated into the fiber for efficient electrical control of the voltage-tuned phase/amplitude modulation as illustrated in FIG. 5C, enabling dynamic manipulation of optical guidance and complex wavefront of the guided light/laser. Moreover, the guiding properties of the zero-index hollow core fiber with high speed and high-power laser pulse guidance in meter-scale fiber lengths may be considered. Due to the high damage threshold of conducting oxide materials (˜1000 GW/cm2), and because the laser is guided in the air, the structure may sustain high-power radiation. The data transmission rate may be examined with different geometries of zero-index fiber as appropriate to the requirements of a specific application in accordance with embodiments of the invention. Furthermore, lasers may be development using zero-index optical fibers such as, but not limited to, discharging gas filled hollow-core fibers for high intensity in-fiber gas lasers and in-fiber molecular/gas sensing and laser-breakdown spectroscopy.

Although zero-index optical fiber fabrication processes are discussed above with respect to FIGS. 5A-5C, any of a variety of materials, configurations, and zero-index optical fiber fabrication processes as appropriate to the requirements of a specific application may be utilized in accordance with embodiments of the invention. While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A zero-index optical fiber comprising:
a core comprising air for propagating light; and
a cladding configured to surround the core, wherein the cladding comprises a zero-index material.

2. The zero-index optical fiber of claim 1, wherein the air has a higher refractive index than the zero-index material.

3. The zero-index optical fiber of claim 2, wherein the air has a refractive index equal to 1.

4. The zero-index optical fiber of claim 3, wherein the zero-index material has a refractive index near 0.

5. The zero-index optical fiber of claim 3, wherein the zero-index material has a real part of permittivity of material near 0.

6. The zero-index optical fiber of claim 1, wherein the light is guided in the zero-index optical fiber via total internal reflection.

7. The zero-index optical fiber of claim 1, wherein the zero-index optical fiber is electrically tunable.

8. The zero-index optical fiber of claim 7 further comprising a negative terminal layer and a positive terminal layer.

9. The zero-index optical fiber of claim 8, wherein the negative terminal layer comprises the zero-index material.

10. The zero-index optical fiber of claim 9, wherein the positive terminal layer comprises gold (AU).

11. The zero-index optical fiber of claim 1, wherein the zero-index optical fiber is fabricated by coating a layer of zero-index material on an inside of a glass capillary fiber.

12. The zero-index optical fiber of claim 11, wherein coating the layer of zero-index material on the inside of the glass capillary fiber is performed using atomic layer disposition.

13. The zero-index optical fiber of claim 1, wherein the zero-index material can be any material that exhibits zero-index property.

14. The zero-index optical fiber of claim 1, wherein the zero-index material can be any material that exhibits epsilon-near-zero property.

15. The zero-index optical fiber of claim 13, wherein the zero-index material is a transparent conducting oxide material.

16. The zero-index optical fiber of claim 15, wherein the transparent conducting oxide material is an indium tin oxide (ITO) material.

17. The zero-index optical fiber of claim 16, wherein the propagated light has various wavelengths and the ITO material can operate in a telecommunication system.

18. The zero-index optical fiber of claim 17, wherein the telecommunication system utilizes wavelength λ=1550 nm.

19. The zero-index optical fiber of claim 1, wherein the core has a thickness of 500 nm or larger.

20. The zero-index optical fiber of claim 19, wherein the cladding has a thickness of 300 nm or larger.
